(19) United States
(12) Patent Application Publication
(10) Pub. No.: US 2022/0282143 A1
(43) Pub. Date: Sep. 8, 2022

(54) Adhesion-promoting composition for a textile material and associated reinforcing textile material

(71) Applicant: PORCHER INDUSTRIES, ECLOSE-BADINIÈRES (FR)

(72) Inventors: Maëlle GOBIN, VALENCE (FR); Louis HOLLANDE, VILLEURBANNE (FR)

(21) Appl. No.: 17/770,325

(22) PCT Filed: Oct. 23, 2020
(86) PCT No.: PCT/EP2020/079918

§ 371 Date: Apr. 20, 2022

(30) Foreign Application Priority Data
Oct. 25, 2019 (FR) 1911954

(51) Int. Cl. C09J 197/00; D06M 15/17; D06M 15/55; C09J 163/00

(52) U.S. Cl. CPC C09J 197/005; D06M 15/17; D06M 15/55; C09J 163/00

(57) ABSTRACT

The invention relates to an adhesion-promoting composition for a textile material, comprising a salt of lignosulphonate, an epoxy hardener for said salt, comprising at least two epoxide units, and an elastomer latex. The lignosulphonate salt can be a lignosulphonate of sodium, potassium, magnesium, ammonium or calcium. The invention also relates to the use of such a composition for providing a reinforcing textile material with adhesive properties, in relation to a rubber material, to a reinforcing textile material, particularly a textile structure, thread or cord, at least partially coated and/or impregnated with said composition, and to a part consisting of rubber or comprising a rubber material, in which the rubber comprises at least one reinforcing textile material, on the surface thereof and/or integrated into the rubber material.

The present invention relates to an adhesive or bonding composition for textiles, in particular a composition for causing a textile to adhere to a rubber. The invention relates in particular to applications in the field of belts, pipes, tires, pneumatic springs (airspring) and, more generally, any part or article made of rubber, or comprising a part made of rubber, in which the rubber comprises a reinforcement textile on the surface and/or in depth (in the mass). The invention thus also relates to reinforcement textiles coated with this adhesive, and the parts or articles incorporating them both on the surface and in depth.

### BACKGROUND OF THE INVENTION

To take the example of transmission belts, the textile reinforcement must first and foremost ensure the dimensional stability of the belt. To this end, the reinforcement is required to have specific mechanical properties in various environments. To ensure the required properties, and in particular to avoid a risk of delamination, the textile reinforcement must adhere to the rubber of the belt. The reinforcement may be in contact with one rubber or several different rubbers. To allow good compatibility with rubber, the reinforcement is generally treated with an adhesive. More complex properties may also be required from the reinforcement. For example, the edge of the reinforcement, upon being cut and exposed at the side of the belt, must not fray, while however being easy to cut. To guarantee these other properties, other types of treatments may be applied to the yarn.

To obtain all of these properties, it is necessary to provide structure to the yarn, especially in the form of a cord, and to provide several chemical and heat treatments.

Since several different treatments are applied to the textile reinforcement, it is imperative to ensure the compatibility of the adhesive with the reinforcement, the rubber and also the other treatments applied to the reinforcement.

The primary purpose of chemical treatments is to cause a given reinforcement to adhere to the various rubbers that it may encounter. The treatments are as varied as there are types of reinforcements [glass, aramid, polyamide (PA), polyethylene terephthalate (PET), etc.] and rubber families.

At the core of the treatment for causing a reinforcement textile to adhere to the rubber is the so-called resorcinol-formaldehyde-latex or RFL treatment. It is a system involving mixing a latex (colloidal aqueous dispersion of elastomer or polymer) and thermosetting resins of the phenoplast or aminoplast type. This system is historical; it was widely developed in the 70s and remains the treatment of choice. Despite numerous attempts to replace the latter, it has never been possible to provide a comprehensive solution to achieve equivalent performance until now. It is totally optimized to obtain the maximum static adhesion, i.e. without dynamic stress.

The heat treatment has an impact on the chemical properties (adhesion) but also on the mechanical properties in the case of synthetic reinforcements. It impacts the shrinkage characteristics, among others. The treatment in the ovens results from the concordance between the maintenance of the mechanical properties and the crosslinking of the adhesive.

For all these reasons, the new treatment must therefore be able to adapt to current treatment conditions, in order to ensure the mechanical properties. However, an adhesive allowing treatment at a lower temperature will potentially provide new and interesting properties in certain applications, and will exhibit a favorable energy aspect.

However, to improve adhesion performance, or to provide abrasion resistance, up to four different treatments may need to be applied to a textile successively, including the treatment with RFL. These are the following treatments:
1) The core treatment of the yarn which allows the filaments to be trapped in a matrix and to block the filaments therebetween. It thus gives resistance to fraying and makes the yarn stiff.
2) Pre-activation, to improve adhesion.
3) RFL treatment, in one or two layers.
4) Overcoats in the form of commercial adhesion promoters, or solutions of elastomers (sometimes called cementation).

It is therefore also preferable that any change in a formulation does not call into question the functionality of the various chemical and thermal (or physical, more generally) treatments usually used for various applications.

Considering all the constraints mentioned above, the RFL treatment has established itself as the treatment of choice enabling adhesion between the textile and the rubber. The phenomena involved in adhesion are brought into play during the vulcanization of the rubber part, while the RFL treatment itself may be applied to the textile several months earlier. This is why the term “bonding” treatment is often used, the term “adhesion” being rather reserved for the state of adhesion. In RFL, latexes are aqueous colloidal dispersions of elastomers or polymers, generally similar in nature to the rubber to be bonded. However, these latexes do not have real mechanical properties on their own. To ensure the strength of the system, a thermoset (thermosetting) resin is added. This is RF resin, made from resorcinol and formaldehyde. Via its polarity, it provides for good adhesion to the textile. It forms a mesh in which the latex is trapped, which stiffens the system. This mesh remains sufficiently flexible to allow the diffusion of the elastomer chains in the matrix and then create good adhesion to the rubber (entanglement, molecular interactions and possibly co-crosslinking during vulcanization).

RFL contains formalin and resorcinol which are currently known to be suspected carcinogens. It would therefore be of interest to find an alternative to this formalin and to resorcinol or to the RFL composition as a whole. The complex properties of RFL, both in terms of its implementation and in the properties of use of the end products incorporating it, which were reiterated above, make the exercise of finding an alternative solution a real challenge. It would be of even greater interest to find such a solution which is more than an alternative, but which also offers an enhancement in performance. These are the challenges that the inventors set out to overcome.

The object of the invention is thus to provide new adhesion solutions which make it possible in particular to replace RFLs in their known applications, and offer performance levels that are close or even superior thereto, with this being achieved with components that are acceptable in the context of sustainable development and under favorable economic conditions.

Lignosulfonates are offered as a natural adhesive and as a short fiber binder for making mats (nonwovens) in combination with lignosulfonate hardeners, or as adhesives in multi-layer wood-based products. They have never been proposed in alternative compositions to RFLs and there is no indication that lignosulfonates could prove to be suitable for developing adhesion formulas to ensure a bond with rubbers and offering sufficient mechanical performance. They are also used as surfactant in compositions that thus then contain no hardener, as described in the patent documents JP2002226812 and JP2001234143.

### SUMMARY OF THE INVENTION

The object of the invention is therefore a composition comprising (or based on, consisting essentially of, or consisting of) a lignosulfonate salt, an epoxy hardener of this salt, and a polymer latex, in particular of elastomer. It is in particular an adhesive composition or bonding composition for textiles.

The term “epoxy hardener” as described in the invention, is understood to refer to a compound comprising at least 2 epoxy units, or oxacyclopropane, or —CH—CH₂-0 ring. This compound can react by addition with components such as alcohols by opening the epoxy ring. The presence of two epoxy units makes possible the reaction with 2 units containing alcohols and therefore a polymerization reaction, also known as crosslinking. The epoxy hardener according to the invention is therefore a crosslinking agent for crosslinking the lignosulfonate salt.

An object of the invention is also a composition, in particular an adhesive—, or bonding composition for textiles, which is obtained or capable of being obtained by the mixing of a lignosulfonate salt, an epoxy hardener of this salt, and a latex of polymer, in particular of elastomer. In one embodiment, the composition is as obtained or capable of being obtained by the mixing of a lignosulfonate salt and an epoxy hardener of this salt, in a basic medium, followed by the adding of a polymer latex, in particular of elastomer latex; or by the mixing of a lignosulfonate salt in a basic medium and a polymer latex, in particular an elastomer latex, followed by the adding of an epoxy hardener of this salt.

In one embodiment, the composition comprises a product resulting from the reaction between the lignosulfonate salt in a basic medium and the epoxy hardener of this salt.

The compositions may be bonding compositions that are used for causing textiles to adhere to a rubber or similar material. These compositions are compositions that can be applied on to a substrate, such as in particular a textile, in particular the textiles according to the invention. The invention also relates to the method of preparation thereof.

An object of the invention is also these compositions that are dried and cured after undergoing a suitable treatment process such as a heat treatment. The term “drying” is understood to refer to the evaporation of water or volatile matter. The term “curing” is understood to refer to any polymerization or crosslinking reaction, whether total or partial, of the compounds that are present in the composition and capable of reacting under the treatment conditions applied, including without the need for heat treatment. These dried and cured compositions are then generally associated with a substrate, such as in particular a textile, in particular the textiles according to the invention, or else with rubber parts, or the like, that incorporate these textiles. The term “associated” is used to indicate that the composition impregnates the textile, coats the textile, or impregnates and coats the textile. The coating may be continuous or discontinuous. The impregnation may be complete and to the core or partial.

An object of the invention is also a kit or set that includes a first composition comprising a lignosulfonate salt and a polymer latex, in particular an elastomer latex; and a second composition comprising an epoxy hardener of the lignosulfonate salt. The first and second compositions are suitable therefor and intended to be mixed in order to form the bonding composition, prior to the latter being applied on to a textile within the meaning of the invention.

The invention also relates to an application method for applying a bonding composition according to the invention, to impart adhesion properties to a reinforcement textile, with respect to a rubber or the like. This method will include the drying and curing of the composition, by means of a suitable treatment process such as heat treatment.

The invention also relates to the use of a composition according to the invention or of a dried and cured bonding composition, in order to impart adhesion properties to a reinforcement textile, with respect to a rubber or the like.

The invention also relates to a reinforcement textile, in particular yarn, cord or textile structure, at least partially coated and/or impregnated with a bonding composition according to the invention, which is in particular dried and cured.

The invention also relates to an article or part made of rubber (or similar material) or comprising a part made of rubber (or similar material), in which the rubber comprises at least one reinforcement textile according to the invention, on the surface and/or integrated inside the rubber or rubber matrix.

Other objects of the invention will become apparent upon reading the detailed description which follows.

### DETAILED DESCRIPTION

The first object of the invention is therefore an adhesive or bonding composition for textiles, comprising (or based on, consisting essentially of, or consisting of) at least one lignosulfonate salt, at least one epoxy hardener of this salt, and a latex of elastomer.

Without intending to be bound by theory, it is believed that the lignosulfonate salt and the epoxy hardener of that salt, by definition, react together so as to yield a reaction product when they are mixed together and whether or not the mixing is subjected to heat, such as a heat treatment which will be applied to the textile once coated and/or impregnated with the bonding composition. It is expected that the lignosulfonate salt initiates a reaction with the epoxy hardener in a crosslinking reaction by adding the reactive units of the lignosulfonate to the epoxy rings and opening this ring, when the compounds are subjected to heat. This heat may be applied during a heat treatment process such as the heat treatment applied to a textile after coating and/or impregnation with the bonding composition. Since the epoxy hardener contains at least 2 epoxy units, it is expected that there will be a crosslinking reaction, and therefore formation of a polymer or a resin. In one favorable embodiment, this reaction is expected to be favored by the presence of a basic medium. This reaction state has been studied and described in greater detail in part I of the Examples. However, the possibility of one or more reaction mechanisms between the lignosulfonate salt and the epoxy occurring during preparation or storage cannot be excluded. The term “reaction product”, as is self-evident, is understood to refer to the product of the reaction between the lignosulfonate and the epoxy hardener, which does not include any additives that could enter into the final composition.

This composition may in particular be obtained by a method, which is also an object of the invention, according to which the three ingredients are mixed with stirring.

As illustrated in the examples, according to a first embodiment, the lignosulfonate salt may be dissolved in water before mixing the solution obtained with the latex and the epoxy. This solubilization may be facilitated by working in a basic medium, by adding a soda and/or ammonia type agent. According to one method, the lignosulfonate salt solution and the latex are mixed first, and only thereafter is the epoxy added. According to another method, the lignosulfonate salt solution and the epoxy hardener are mixed first, then only thereafter is the latex added, the aforementioned thus constituting two modalities. It is to be noted that, unless otherwise indicated, the term “addition”, may be understood to refer to the adding of the first product to the second, or vice versa.

In one embodiment of the preparation method, the lignosulfonate salt may be dissolved in water with stirring and in the presence of the agent allowing the pH to be basic, the mixture is stirred until solubilization, preferably total; it is then added, while stirring, to the latex, before incorporating, still with stirring, the hardener (preferably the latter is dissolved or dispersed beforehand in water, e.g. with vigorous stirring). According to one practical modality, the mixture of lignosulfonate salt and the latex is added to the epoxy hardener solution or dispersion. The mixing with the epoxy hardener may be carried out subsequent to the preparation of the lignosulfonate and latex mixture, or later, as in the case of the kit or set which is the object of the invention. The composition may be used as a ready-to-use bonding composition or one that may be custom-diluted on demand.

According to another embodiment of the method, it is possible to mix an aqueous solution of lignosulfonate and of epoxy hardener, before adding the mixture with stirring, to an aqueous dispersion of latex. According to one practical modality, the mixture of lignosulfonate salt and epoxy hardener is added to the latex. Advantageously, the pH of the solution of lignosulfonate or of lignosulfonate and of hardener is adjusted to be basic, for example by adding sodium hydroxide and/or ammonia, before incorporation of the latex. The composition may be used as a ready-to-use adhesive composition or one that may be custom-diluted on demand.

The characteristic features that follow are applicable to the various objects of the invention.

The latex is preferably a basic aqueous dispersion of the polymer(s) and/or elastomer(s). It is also possible to work according to the invention at neutral pH. The working pH values may in particular be those mentioned below with regard to the pH of the composition.

The term “elastomer” is, in particular, understood to refer to a polymer or copolymer chain whose glass transition temperature (Tᵥ) is less than approximately 25° C. Elastomers are present in the rubber to be bonded and in the latex of the bonding composition. An “elastomer latex” is a colloidal aqueous dispersion of an elastomer.

The terms “rubber” or “elastomeric material” herein are understood to refer to the vulcanized or crosslinked product prepared from elastomer or elastomeric rubber, whether synthetic or natural, of one or more types of filler(s), reinforcing agent(s) (carbon blacks, silica, kaolins, etc.), plasticizer(s), vulcanizing agent(s) (sulfur, peroxide, metal oxides and the necessary accelerators), any other usual additives for the application in question (for example to facilitate the implementation, for protection against oxygen, ozone, heat, flame, UV). The invention also relates to both synthetic rubbers and natural rubber. Rubbers, formulated on the basis of elastomers, are materials whose obtained Tᵥ is lower than the service temperature, the operating temperature, or application/usage temperature of the mechanical parts or assemblies formed with the one or more rubber(s).

Lignosulphonates are by-products resulting from the transformation of wood, in particular from the treatment of wood for the manufacture of paper pulp according to the method known as the “acidic bisulphite cooking method”. This method, which uses a bisulfite, makes it possible, depending on the nature of the counterion used, to obtain the corresponding lignosulfonate salts. These lignosulfonates may also be derived from a method intended to produce them from wood.

Preferably, in the bonding composition, the lignosulfonate salt may be a sodium, potassium, magnesium, ammonium or calcium salt.

In one exemplary embodiment, lignosulphonates prepared by the bisulphite method from maritime pine, for example originating from Landes (France), are used.

Preferably, the bonding compositions do not include formaldehyde or formalin. Preferably, the bonding compositions do not include resorcinol. Preferably, the bonding compositions do not include formaldehyde or formalin, and resorcinol. Preferably, the bonding compositions do not include an organic solvent. They use water as a solvent, the pH of which may be adjusted as needed.

The epoxy hardener according to the invention is a polyepoxy compound comprising at least 2 epoxide or epoxy groups or units. Mention may in particular be made of those which contain on average more than one glycidyl or -methyl-glycidyl radical borne by a heteroatom, preferably an oxygen or nitrogen atom, more particularly an oxygen atom; or those which contain on average more than one epoxy-cyclo-hexyl group. It is possible to use several different compounds from the following lists.

By way of hardener, mention may be made in particular of the following:
diglycidyl or poly-glycidyl ethers of aliphatic polyols;
diglycidyl or poly-glycidyl ethers of polyfunctional phenols;
poly-glycidyl ethers of condensation products of phenols with formaldehyde obtained under acidic conditions;
di- or poly-glycidyl esters of aliphatic or aromatic polycarboxylic acids;
compounds containing epoxycyclohexyl groups;
polyepoxy compounds resulting from the epoxidation of an olefinically unsaturated compound

Mention may be made in particular of the following:
diglycidyl or poly-glycidyl ethers of aliphatic polyols such as butanediol-1,4; hexane-diol-1,6; 1,2,6-hexane-triol; glycerol; neopentylglycol; ethylene glycol; triethyleneglyycol; 1,2 propylene glycol or polyalkylene glycols such as polypropylene glycols; or derivatives of polyalkylene glycols, for example polypropylene glycols;
diglycidyl or poly-glycidyl ethers of polyfunctional phenols such as 2,2-bis(4-hydroxyphenyl)propane (or BPA); 2,2-bis(4-hydroxyphenyl)hexafluoropropane (or BPA-F); 1,1-bis(4-hydroxyphenyl)-1-phenyl-ethane (or BPA-P); 2,2-bis(4-hydroxyphenyl)butane (BPB); bis-(4-hydroxyphenyl)diphenylmethane (or BPBP); 2,2-bis(3-methyl-4-hydroxyphenyl)propane (or BPC); bis(4-hydroxyphenyl)-2,2-dichlorethylene (or BPCII); bis(4-hydroxyphenyl)methane (or BPF); 4,4′-(9H-fluoren-9-ylidene)bisphenol (or BPFL); 2,2-bis(4-hydroxy-3-isopropylphenyl)propane (or BPG); 1,3-bis(2-(4-hydroxyphenyl)-2-propyl)benzene (or BPM); 1,1-bis(4-hydroxyphenyl)cyclohexane (BPZ) and the like;
polyglycidyl ethers of condensation products of phenols with formaldehyde obtained under acidic conditions: novolacs of phenol and novolacs of cresols, and the like;
ethers of compounds containing epoxycyclohexyl groups such as 3,4-epoxycyclohexylmethyl 3,4 epoxycyclohexanecarboxylate; epoxy-8,9 (epoxy-3,4 cyclohexyl)-3 di-oxa-2,4 spiro 5.5 undecane; and bis-(3,4-epoxy cyclohexylmethyl) adipate, and the like;
di- or poly-glycidyl esters of polycarboxylic acids such as phthalic acid, terephthalic acid, A -tetrahydrophthalic acid, hexahydrophthalic acid, trimellitic acid, oxalic acid, succinic acid, glutaric acid, dimerized linolenic acid, and the like.

The epoxy hardener may in particular be selected from among the compounds listed here below, it being understood that the composition may incorporate one or more of them, in particular 2 of them:
1,4 butanediol diglycidyl ether (Diglycidyl ethers of aliphatic polyols)
2,2-bis(4-hydroxyphenyl) propane diglycidyl ether (Diglycidyl ethers of polyfunctional phenols)
Diglycidyl 1,2-cyclohexanedicarboxylate (Di- or poly-glycidyl esters of polycarboxylic acids)
3,4-epoxycyclohexylmethyl 3,4 epoxycyclohexanecarboxylate (Compounds containing epoxycyclohexyl groups)
1,6 hexanediol diglycidyl ether (Diglycidyl ethers of aliphatic polyols)
Glycerol diglycidyl ether (Diglycidyl ethers of aliphatic polyols)
Glycerol triglycidyl ether (Polyglycidyl ethers of aliphatic polyols)
Mixture of glycerol diglycidyl ether and glycerol triglycidyl ether, for example marketed by the company Raschig under the product reference GE100 (Diglycidyl ethers of aliphatic polyols)
Novolac type epoxy resins, for example marketed by the company HUNTSMAN under the product reference Araldite PZ 323 (Polyglycidyl ethers of condensation products of phenols with formaldehyde).

The epoxy hardener may also be selected from among N-glycidyl derivatives of heterocyclic amines, amides and nitrogenous bases, for example: N,N-diglycidyl-aniline; N,N-diglycidyl-toluidine; N,N,N′,N′ tetrakis-glycidyl bis-(4-amino phenyl)-methane; triglycidyl derivative of 4-hydroxy aniline; triglycidyl isocyanurate; N,N′-diglycidyl-ethylene-urea; N,N′-diglycidyl-5,5-dimethyl hydantoin; N,N′-diglycidyl isopropyl-5 hydantoin; and N,N′-diglycidyl-5,5-dimethyl-6-isopropyl-5,6-dihydro-uracil.

The latex may advantageously be a latex of acrylonitrile/carboxylated butadiene copolymer (XNBR), a latex of acrylonitrile/hydrogenated butadiene (HNBR), a latex of chlorosulfonated polyethylene (CSM), a latex of styrene-butadiene-vinylpyridine copolymer (VPSBR), a styrene/butadiene copolymer latex (SBR), an acrylonitrile/butadiene copolymer latex (NBR), a polybutadiene latex (BR), a chlorobutadiene latex (CR), a natural rubber latex (NR), a polyurethane latex, or a mixture of at least two of them.

The dry matter content of the composition by weight may be in particular between approximately 2 and approximately 38%, in particular between approximately 4 and approximately 30%, more particularly between approximately 7 and approximately 25%.

The composition according to the invention may in particular comprise from about 40 to about 95%, preferably from about 55 to about 90% or from about 40 to about 60, 70, 80 or 90% by weight of elastomer relative to the composition.

Unless otherwise indicated, the composition is given as a dry matter.

In the composition, the hardener/lignosulfonate salt mass ratio may be in particular between approximately 0.01 and approximately 5, more particularly between approximately 0.03 and approximately 1, typically between approximately 0.05 and approximately 0.5. Lower or higher values may prove to be possible depending on the hardener and lignosulfonate salt pairs selected and this parameter may be determined by a person skilled in the art on the basis of this description.

In the composition, the [hardener+lignosulfonate salt]/latex mass ratio may be in particular between approximately 0.05 and approximately 0.6, more particularly between approximately 0.15 and approximately 0.5. Lower or higher values may prove to be possible depending on the compounds selected in combination and this parameter may be determined by a person skilled in the art on the basis of this description.

According to an advantageous characteristic, the composition has a neutral or basic pH, in particular a pH of between approximately 7 and approximately 13, in particular between approximately 9 and approximately 13. The composition may comprise for this purpose an additive making it possible to adjust the pH, for example soda.

The composition comprises the water of the elastomer latex. Water may still be added, in order to make the applicable composition sufficiently fluid for a conventional application, for example by impregnation.

The composition may also comprise additives at a content in particular of between approximately 0.01 or 0.1 and approximately 50% by dry mass. The composition may in particular comprise a bonding or adhesion promoter that is soluble in aqueous medium (for example silane, blocked isocyanate), a surfactant, a dispersant, an antifoam agent, a wax (for example microcrystalline hydrocarbon wax in emulsion), a filler (for example carbon black, silica), a colorant, a metal oxide (for example zinc oxide ZnO), an elastomer crosslinking agent, an anti-UV agent, an anti-ozone agent, a heat-protective agent. These agents are additives that are conventionally used in RFL formulations. They are compatible with the adhesive that is the object of the invention.

In one embodiment, the bonding composition for textiles is constituted essentially of a lignosulfonate salt, an epoxy hardener of this salt, and an elastomer latex, and may comprise one or more additives, in particular one or more of the additives mentioned in the preceding paragraph. Advantageously, the compositions according to the invention do not comprise any conventional catalyst or hardener for compounds containing an epoxy group or unit, such as triethylenetriamine (TETA) and triethylamine (TEA).

The viscosity of the bonding composition is measured at 23° C. using a Brookfield viscometer, for example equipped with a ULA module suitable for low viscosities. As is detailed in the examples, the viscosity may be adjusted by adjusting in particular the water content. The viscosity may be adjusted in a manner so as to obtain the desired level in order to enable good application to the textile in the coating process or impregnation process used. In the case of impregnation by dipping, this viscosity may in particular be between approximately 1 and approximately 10, typically between approximately 1 and approximately 5 Cp or mPa·s.

The composition according to the invention may be applied to any textile. The term “textile” within the meaning of the invention, is understood to refer to: continuous monofilament yarn, continuous multifilament yarn, staple fiber, any assembly of monofilament and/or multifilament continuous yarns or chopped yarn, in particular a wick, a cord formed from such yarns by conventional twisting techniques and a “textile structure” formed from the assembly of yarns, twisted or cabled, in particular in the form of fabric, grid, etc. The textiles of the invention, having been treated with the composition according to the invention, are designated by the expression “reinforcement textiles”.

The textile may be organic or inorganic in nature. By way of the type of textile, mention may in particular be made of glass (in particular E glass or high modulus glass), basalt, carbon, aramid (meta or para), polyvinyl alcohols, cellulose, high density polyethylenes (HDPE), polyester (in particular polyethylene terephthalates, PET), polyamides (PA, in particular PA 4.6, PA 6.6, PA 6), acrylics, hybrids (aramid yarn+nylon yarn, cabled together; acrylic+glass+copper, cabled together), etc. When the textile is a cord or a textile structure of several yarns, the yarns may all be organic or inorganic in nature, or the cord or the textile structure may comprise both types of yarns, organic and inorganic.

An object of the invention is also an application method for applying, or using, a bonding composition according to the invention, to impart bonding properties to such a textile, in particular with respect to an elastomeric material. This use may be broken down in terms of the method of bonding a textile according to the invention. This use or method comprises applying said composition to the textile (yarn, cord, textile structure), then drying it. This application may be carried out by the methods in use in the industry, for coating, in particular by impregnation, as described below. The choice of latex, and therefore of the constituent elastomer, advantageously leans towards a formula similar to the nature of the constituent elastomer of the rubber to be treated.

In one embodiment, the impregnation of the textiles is carried out by “dipping” in tanks containing the adhesive preparations.

The yarns, cords and cables may in particular undergo either a direct dipping process in a tank, or an impregnation by means of a lick roller, for the application of the bonding composition. After dipping or impregnation, the excess wet preparation is preferably removed, for example by pressing (padding), spinneret-die, suction or by physical compression between porous supports such as foams. After dipping or impregnation, and possibly the eventual removal of the excess preparation, the drying and heat-setting of the bonding composition are then carried out. The coated impregnated textile may thus be subjected to passage through an oven in order to enable the drying and crosslinking of the bonding composition. After removal from an oven, the textile may again undergo an impregnation step (by dipping or impregnation by a lick roller), then passage through an oven, these steps being able to be repeated, in particular up to a total of 4 impregnations (2, 3 or 4).

In another method of impregnation, which is particularly suitable for mineral fibers (glass, basalt, carbon, etc), a derivation system made up of a comb and/or “pig tails” may be used before the impregnation of a multifilament yarn. It allows maximum opening of the multifilament yarn, to promote thorough impregnation. After dipping or impregnation with a lick roller as above, the excess wet preparation is preferably removed, for example by pressing (padding), suction or by physical compression between porous supports such as foams. After dipping or impregnation, and possibly the eventual removal of the excess preparation, the drying and heat-setting of the bonding composition are then carried out. The coated impregnated yarn may thus be subjected to passage through an oven in order to enable the drying and crosslinking of the bonding composition. After removal from an oven, the yarn may again undergo an impregnation step (by dipping or impregnation by a lick roller), then passage through an oven, these steps being able to be repeated, in particular up to a total of 4 impregnations (2, 3 or 4).

After the steps of impregnation, and drying, and heat-setting of a yarn, the yarn is then twisted in line. The cabling is preferably carried out on a yarn that has already been treated, but it is also possible to first perform the cabling and then perform the steps of impregnation and drying and heat setting. In the various different methods, the speeds may range from 1 m/min to 150 m/min, with the temperatures of the ovens ranging from 30° C. to 350° C., more specifically from 100 to 300° C., and even more specifically from 140 to 220° C. Mechanical tension may also be applied to the textile throughout the process.

One embodiment relates to the production of a textile reinforcement for incorporation into assemblies such as transmission belts or conveyor belts. For this purpose, a cord, for example made of polyamide such as PA 4-6, is constructed by twisting, and then cabling. The cord obtained may optionally and advantageously be treated by a first core impregnation process intended to block the filaments therebetween and confer to the yarn resistance to fraying, thereby also making the yarn stiff; this may be effected with a solution of methylene diphenyl diisocyanate in toluene; the impregnated cord is then subjected to drying and heat setting in an oven. The cord is thereafter impregnated in a tank containing an adhesive composition of the invention, and then dried and heat set in the oven.

Another embodiment relates to the production of a textile reinforcement for incorporation into profiles and seals, such as window or door seals. Such reinforcements may in particular be made from glass yarn containing a glass fiber sizing with which the adhesive composition is to be compatible. It is possible to proceed by starting with glass yarns (in particular E-glass), the latter being subjected to a derivation process (see above) and to an impregnation process in the tank containing a bonding composition of the invention. The impregnated yarns were subjected to drying and heat setting in an oven. On being removed from the oven, the yarns undergo a twisting operation. A plurality, for example three, impregnated twists may then be cabled together.

Another embodiment relates to the production of a textile reinforcement designed to serve as a braided, coiled, wrapped or knitted reinforcement, in a brake pipe. It is possible to start from a yarn made of organic material, for example polyethylene terephthalate (PET), high density polyethylene (HDPE), or polyamide. Preferably a twist is applied thereto. The yarn, preferably twisted, is subjected to treatment by impregnation in a bonding composition of the invention, then by drying and heat setting in an oven.

By way of a variant of this embodiment, it is possible to start from similar yarns, with a cord then being constructed by means of successive steps of twisting, and then cabling. The cord obtained is treated by a first core impregnation process intended to block the filaments therebetween and confer to the yarn resistance to fraying, thereby also making the yarn stiff, for example by using a solution of methylene diphenyl diisocyanate in toluene; it is then subjected to drying and heat setting in an oven. The cord obtained is thereafter treated by impregnation in a bonding composition of the invention, and then by drying and heat-setting in an oven.

Other characteristic features pertaining to the use or the method will become apparent on reading the remainder of the description.

The object of the invention is also a reinforcement textile that is coated and/or impregnated with a bonding composition according to the invention. The object of the invention is in particular a reinforcement textile that is coated and/or impregnated with a bonding composition and capable of being obtained by implementing the methods described herein. It also relates to the textile treatment method for treating the textile in order to produce the reinforcement textile, by applying the adhesive composition to said textile.

An object of the invention is in particular a yarn coated and/or impregnated with a bonding composition according to the invention. The yarn may be a twisted yarn, and the twisting may take place before or after application of the composition, and drying and/or curing thereof. When the yarn is multifilament, it may be fully impregnated to the core, and this could possibly have been obtained if necessary by splitting the yarn (spacing of the filaments by means known to those skilled in the art) before impregnating it with the composition. This yarn may in particular comprise, or be coated with, the cured bonding composition (dried and/or crosslinked).

An object of the invention is also a cord coated and/or impregnated with a bonding composition according to the invention. This cord may in particular comprise, or be coated with, the cured bonding composition (dried and/or crosslinked).

The cord may be formed from at least two yarns that are not coated or impregnated with the adhesive composition; generally each yarn is first twisted, then the yarns are cabled (assembled together and twisted in the direction opposite to that of the twist of the elementary yarns), and thereafter the cord is impregnated with the adhesive composition, which is cured after application.

The cord may also be formed by the assembling of at least two yarns that are coated or impregnated with the adhesive composition; generally each yarn is twisted after solidification of the composition, and then the yarns are cabled (assembled together and twisted in the direction opposite to that of the twist of the elementary yarns); it being possible thereafter to provide for a coating process for the cord along with other treatment processes (“overcoat” or “topcoat”), and the drying thereof.

The object of the invention is also a textile structure formed by assembling yarns by known techniques such as weaving or by gluing or welding in the case of grids. These textile structures are coated or impregnated with the composition of the invention, and the invention covers such textile structures that are coated with the cured bonding composition.

The bonding compositions may be applied to textiles within the meaning of the invention by the methods used for RFLs. To be retained firstly, is the impregnation, by direct dipping or by means of a lick roller.

The object of the invention is also an article or part made of rubber (or one comprising a part made of rubber), comprising at least one reinforcement textile, in particular yarn, cord and/or textile structure, according to the invention. This reinforcement textile may in particular be applied to the surface of the article or part and/or integrated inside the article or part.

As has been said, rubber is a vulcanizable formulation based on natural or synthetic elastomers, such as vulcanized (crosslinked) natural rubber (NR or polyisoprene), or a synthetic, vulcanized (crosslinked) rubber. As examples of synthetic rubber, mention may be made of rubbers of: polybutadiene (BR), polyurethane (AU or EU), polychloroprene (CR), silicone (VMQ, PVMQ) and fluorosilicone (FVMQ), ethylene-propylene-diene monomer (EPDM), butadiene-acrylonitrile copolymers (NBR for nitrile butadiene rubber), hydrogenated butadiene-acrylonitrile copolymers (HNBR), styrene/butadiene copolymer (SBR), epichlorohydrin (ECO or CO), butyl (IIR), bromobutyl (BIIR), chlorobutyl (CIIR), chlorinated polyethylenes (CM), chlorosulfonated polyethylenes (CSM), carboxylated nitrile butadiene acrylonitrile (XNBR), copolymers of ethylene and methyl acrylate (AEM), copolymers of ethylene and vinyl acetate (EVM and EVA), polyacrylates (ACM), fluorinated rubbers (FKM), perfluorinated rubbers (FFKM).

A rubber may also be a vulcanizable formulation based on mixtures or cuts of such elastomeric gums.

The rubber may also be a formulation based on thermoplastic elastomers (so-called “physically crosslinking” elastomers such as SBS, styrene-butadiene-styrene block, for example).

The object of the invention is in particular an article or part made of elastomer or rubber that comprises—either embedded within its mass made of elastomer or rubber, or flush with the surface—a reinforcement textile bonded according to the invention, for example one or more yarns, that may be individual or cabled or else assembled in textile structures, or of more than one of these categories.

The term “bonded” is understood to indicate in particular that the reinforcement textile comprises or is coated with the cured (dried and/or crosslinked) bonding composition.

The object of the invention is also an article or part made of elastomer or rubber that comprises, embedded within its mass made of elastomer or rubber, one or more yarns, that may be individual or cabled or else assembled in textile structures, or of more than one of these categories, and comprising in addition, bonded or adhered to at least one surface of this elastomeric or rubber material, a textile structure according to the invention, these reinforcement textiles being adhered in accordance with the invention.

By way of articles, mention may be made without being exhaustive, of the articles listed below, which may incorporate at least one reinforcement textile adhered or bonded according to the invention, in particular yarn, cord or textile structure treated with the bonding composition of the invention, which is applied on the surface of the article to which it adheres and/or is integrated inside the elastomeric material of the article:
Belts, in particular transmission belts, synchronous belts, conveyor belts, elevator belts, V-belts. The belts may include yarns or cords embedded in the mass of elastomer or rubber. They may also comprise, instead of or in addition to the yarn and cords, a textile structure, in particular a fabric, adhering to the surface, for example on the back in the transmission belt, and on the back and the notch for the distribution belt.
Flexible or rigid hoses, in particular brake hoses (comprising a braided textile structure, either single or double braid), hoses, industrial hoses (comprising a wrapped or spiraled textile structure, that is to say manufactured by wrapping or by spiraling), including oil and gas hoses, hoses (knitted textile structure).

Braiding, spiraling, knitting is generally carried out during the implementation of the pipe by extrusion.
Specialty items: pneumatic springs (“air-springs”), kinetic coupling discs, pipe plugs, compensation/offset seals.
Tires: in particular for heavy goods vehicles and racing.

Included by way of examples of rubber composition for these articles: transmission belt: based on EPDM or CR; synchronous belts: based on HNBR and CR; Hoses: based on SBR, or EPDM, or an NBR/PVC blend, or epichlorohydrin, or butyl; Airspring: based on CR; kinetic discs: based on CR or NR; tires: thick part comprising several mixtures, based on NR, BR or SBR.

The invention has the advantage of being integrated into the recovery of renewable non-food raw materials. It enables the recovery of lignin, currently a waste from the wood and paper industry. This compound is perfectly harmless, has a low cost, and high performance. The use thereof in this context does not constitute any competition for the food market, and it is not subject to regulations on chemical products. This is an agro-resource.

The invention will now be described in greater detail with the aid of embodiments taken into consideration by way of non-limiting examples.

### Part I Preparation of the Formula Comprising a Lignosulfonate Salt and an Epoxy Hardener (Two-Component Example).

The phenomenon of crosslinking or “cooking” of a thermosetting material, that is to say the formation of a three-dimensional covalent network resulting in a reaction product, is accompanied by the release of heat. Thus, the differential scanning calorimeter (DSC) is conventionally used in order to characterize the crosslinking of a thermosetting material. This is accomplished by subjecting an uncooked thermosetting material to a controlled temperature ramp followed by analysis of the location, size and shape of the resulting exothermic peak.

A few grams of sodium lignosulfonate (Arbo N18; Tembec N18) and an epoxy hardener (1,4 butanediol diglycidyl ether) are homogenized for 2 minutes in an aluminum cup under a hood at ambient temperature. The lignosulfonate salt/epoxy hardener mass ratio is precisely 1. Thereafter a few milligrams of this composition are sealed in an aluminum crucible having a diameter of 43 mm and a depth of 12 mm. The sample is then placed in the DSC equipment, DSC 3+ STAR^{e}SYSTEM from METTLER TOLEDO, and subjected to a temperature ramp from 25 to 300° C., at 10° C. per minute, under a flow of nitrogen at 80 ml per minute. The total enthalpy variation to which the sample is subjected is recorded by integrating the surface under the exothermic peak by using the software STAR SW 14.00, and then normalized into J.g⁻¹. The cooking temperature in ° C., where the crosslinking kinetics are the strongest, is measured at the maximum peak (peakmax) of the exothermic peak with an accuracy of +/−1° C.

The same method is applied in order to produce other compositions containing 2,2-bis(4-hydroxyphenyl) propane diglycidyl ether; diglycidyl 1,2-cyclohexanedicarboxylate; 3,4-epoxycyclohexylmethyl 3,4-epoxycyclohexanecarboxylate; 1,6 hexanediol diglycidyl ether; glycerol diglycidyl ether; glycerol triglycidyl ether; mixture of glycerol diglycidyl ether and glycerol triglycidyl ether marketed by the company Raschig under the product reference GE100; novolac type epoxy resin marketed by the company HUNTSMAN under the product reference Araldite®PZ 323.

The same method is applied in order to produce other samples containing only sodium lignosulfonate.

The same method is applied in order to produce other samples containing only the epoxy hardener.

TABLE 1

| | Exothermic Variation | |
|---|---|---|
| | (in % vs lignosulfonate salt control) | |
| | Lignosulfonate Salt/Hardener Ratio | |
| | 1 | 0 |
| Butanediol diglycidyl ether | 1129 | 0 |
| 2,2-Bis(4-hydroxyphenyl) propane | 1079 | 0 |
| diglycidyl ether | | |
| Diglycidyl 1,2-cyclohexane- | 1058 | 0 |
| dicarboxylate | | |
| 3,4-Epoxycyclohexylmethyl 3,4 | 957 | 0 |
| epoxycyclohexanecarboxylate | | |
| 1,6 Hexanediol diglycidyl ether | 1134 | 0 |
| Glycerol diglycidyl ether | 1199 | 0 |
| Glycerol triglycidyl ether | 1100 | 0 |
| GE100 | 993 | 33 |
| Araldite ® PZ 323 | 595 | 0 |

The change in exothermic energy measured for the control sample containing only lignosulfonate is normalized to 100%.

The compositions containing only an epoxy hardener (lignosulphonate salt/hardener mass ratio of 0) exhibit nil or low exothermic variations, between 0 and 33% relative to the lignosulphonate salt control.

The compositions containing sodium lignosulphonate and an epoxy hardener (lignosulphonate salt/hardener mass ratio of 1) exhibit exothermic energy variations of between 595 and 1199% relative to the lignosulphonate salt control. This high exothermic variation relative to the control is characteristic of the phenomenon of crosslinking or “cooking” of a thermosetting material. The role of the epoxy hardener on the lignosulfonate is clearly apparent here.

### EXAMPLES

### Part II: Examples of Preparation of Adhesive Formula

The definitions and measurement or control methods described in this part are generally applicable on demand, unless otherwise specified.

The dry extract (or mass concentration) of the preparations is defined as the percentage of residual dry matter after evaporation of volatile materials (water, solvent) according to a defined drying method. The analysis is carried out using a desiccator balance, on a wet sample taken with mass m_{ech}=between 2 and 5 grams. The sample is placed in a pre-tared aluminum cup containing a binder-free glass fiber filter, with a surface density of 52 g.m⁻² and a threshold of 1.6 μm. The whole ensemble is then subjected to a temperature of 120° C. until complete stabilization of the mass. The result is expressed in %.

The viscosity of the preparation is measured at 23° C. using a Brookfield viscometer.

Unless otherwise specified, the measurement is carried out using a ULA (Ultra Low Viscosity Adaptator) module and a No. 1 mobile (low viscosity system) at a speed of 60 rpm (revolutions per minute).

The pH of the aqueous preparations is measured using a METLER 340 pH meter, calibrated for measurements in a basic medium using buffer solutions. A glass electrode and 3M KCl electrolyte are used.

Unless otherwise stated, the water used for making the preparations is water of reverse osmosis quality, with a residual conductivity of less than 70 μS/cm.

### Example C.II-1

### Preparation of an Adhesive Based on Sodium Lignosulfonate and an Epoxy Hardener

In a first embodiment of the invention, 64.2 g of sodium lignosulfonate (Arbo N18; Tembec) are dissolved with stirring in 1184 g of water. 2.5 g of a 10% by mass sodium hydroxide solution are then added to the solution, which is maintained under agitation for 10 minutes to allow total solubilization. This solution is added with stirring to 983 g of a styrene-butadiene-vinylpyridine copolymer latex (VPSBR). The whole ensemble is maintained under agitation (150 rpm) during the hardener preparation phase.

35 g of GE100 are taken and stirred vigorously (300 rpm) with 230 grams of water. This solution is added to the preparation of lignosulfonate and latex. The stirring is maintained for a few minutes until complete homogenization.

The preparation has a pH of 10.8, a dry extract (solids content) of 19.43% and a viscosity of 2.45 mPa·s.

The same method was applied in order to produce 2 other compositions by varying the following parameters:

Mass ratio of hardener/lignosulfonate salt: from 56% to 116%

Mass ratio of [lignosulfonate salt+hardener]/latex: from 18% to 21%

% by mass of dry latex in the composition: from 80 to 84%.

In total, 3 compositions were produced.

### Example C.II-2

### Second Preparation Method for Preparing a Sodium Lignosulfonate Adhesive and an Epoxy Hardener

In a second embodiment of the invention, 34.8 g of sodium lignosulfonate are introduced into a container and 782 g of water are added gradually. The solution is stirred at 200 rpm. 20 g of a 10% by mass sodium hydroxide solution and 100.7 g of 20% by mass ammonia are then successively added with stirring to the preparation. The mixture is stirred at 200 rpm for 10 minutes.

The basic solution of sodium lignosulfonate is added with stirring to a latex preparation of a styrene-butadiene copolymer (SBR wet latex; 946 g) and to 157 g of previously homogenized water.

75.5 g of GE100 are stirred vigorously (300 rpm) and 383.75 grams of water are added thereto. This emulsion is immediately added with stirring to the preparation of lignosulfonate and latex. Stirring is maintained for a few minutes until complete homogenization.

The preparation has a pH of 12.2, a dry extract of 19.9% and a viscosity of 2.7 mPa·s.

The same method was applied in order to produce another composition by varying the following parameters:

Mass ratio of hardener/lignosulfonate salt: from 217% to 218%.

Mass ratio of [lignosulfonate salt+hardener]/latex: from 21% to 29%.

% by mass of dry latex in the composition: from 78% to 82%.

In total, 2 compositions were produced.

### Example C.II-3

### Third Preparation Method for Preparing an Adhesive Based on Sodium Lignosulfonate and an Epoxy Hardener

In a third method of preparation of the invention, a basic solution of sodium lignosulfonate is prepared by dissolving 19 g of sodium lignosulfonate with stirring in 955 g of water and adding 19 g of a sodium hydroxide solution at 10% by mass. The preparation is left under stirring at 200 rpm for 10 minutes in order to allow total solubilization.

A basic latex dispersion is prepared by introducing 167 g of water into a container, which is then stirred at 200 rpm. 1049 g of a styrene-butadiene copolymer latex (SBR), then 25 g of an ammonia solution at 20% by mass are thereafter introduced successively. The basic lignosulfonate solution is then added with stirring to the latex dispersion.

49 g of GE100 are stirred vigorously (300 rpm) and 216 grams of water are added thereto. This solution is immediately added with stirring to the preparation of lignosulphonate and latex. Stirring is maintained for a few minutes until complete homogenization.

The preparation has a pH of 12.25, a dry extract of 18.33% and a viscosity of 2.25 mPa·s.

The same method was applied in order to produce 2 other compositions by varying the following parameters:

Mass ratio of hardener/lignosulfonate salt: from 255% to 516%

Mass ratio of [lignosulfonate salt+hardener]/latex: from 16% to 46%

% by mass of dry latex in the composition: from 68% to 86%.

In total, 3 compositions were produced.

### Example C.II-4

### Fourth Preparation Method for Preparing an Adhesive Based on Potassium Lignosulfonate and an Epoxy Hardener

In this method of preparation, 94.5 g of an aqueous solution of potassium lignosulfonate and 63.7 g of GE100 are mixed. 1794.8 g of water are then poured over the mixture with vigorous stirring. 33 g of a 10% by mass sodium hydroxide solution and 166.6 g of a 20% by mass ammonia solution are then successively added to the preparation with stirring. The mixture is left under stirring for 10 minutes, then added with stirring to a chloroprene latex (wet latex CR; 1004 g) in water (176 g).

The preparation has a pH of 12.69, a dry extract of 19.58% and a viscosity of 2.45 mPa·s.

The same method was applied in order to produce 2 other compositions by varying the following parameters:

Mass ratio of hardener/lignosulfonate salt: from 33% to 134%

Mass ratio of [lignosulfonate salt+hardener/latex]: from 20% to 47%

% by mass of dry latex in the composition: from 65% to 79%.

In total, 3 compositions were produced.

### Example C.II-5

### Fifth Preparation Method for Preparing an Adhesive Based on Potassium Lignosulfonate and an Epoxy Hardener

In this method of preparation, 94.5 g of an aqueous solution of potassium lignosulfonate and 63.7 g of GE100 are mixed. 1794.8 g of water are then poured over the mixture with vigorous stirring. 33 g of a 10% by mass sodium hydroxide solution and 166.6 g of a 20% by mass ammonia solution are then successively added to the preparation with stirring. The mixture is left under stirring for 10 minutes, then added with stirring to a dispersion of chloroprene latex (wet latex CR; 1004 g) in water (176 g).

1306 g of this preparation are taken and diluted with stirring in 996 g of water. 36 g of an aqueous dispersion of zinc oxide at 55% by mass, 78 g of an aqueous dispersion of carbon black at 35% by mass and 83 g of an adhesion promoter (blocked isocyanate) are then successively added with moderate stirring.

The preparation has a pH of 12.32, a dry extract of 14.1% and a viscosity of 1.95 mPa·s.

The same method was applied in order to produce 2 other compositions by varying the following parameters:

Mass ratio of hardener/lignosulfonate salt: from 33% to 135%

Mass ratio of [lignosulfonate salt+hardener]/latex: from 20% to 47%

% by mass of dry latex in the composition: from 48% to 59%

In total, 3 compositions were produced.

The compositions of these examples are used in Part pertaining to the treatment of the reinforcement textile.

### Part III—Treatment of the Reinforcement Textile

The definitions and measurement or control methods described in this part are generally applicable on demand, unless otherwise specified. The mechanical characteristics of the treated textiles, such as tensile strength at break, tensile elongation at break, shrinkage, temperature shrinkage, contraction (steaming shrinkage), temperature shrinkage force, linear weight, load rate (Dip pick-up; DPU), stiffness, etc, are measured according to the standards in force in the textile industry. In the context of the present invention, it has been verified that the new treatments did not lead to any modification of these properties, compared to the standard RFL.

The adhesive preparations of the invention are evaluated for their adhesion performance. After coating the textile, the latter is deposited in an unvulcanized rubber matrix, so that the surface of the textile in contact with the rubber remains free of any pollution. The matrix containing the textile is then vulcanized by compression, according to temperature, time and pressure conditions specific to each rubber. The textile+vulcanized matrix assembly forms an adhesion test piece.

The adhesion test pieces may take several forms, described in various international standards, such as ISO 36: 2017. The test pieces, and by extension the test carried out to determine the adhesion, are commonly known to those skilled in the art under names such as Test-T (“pull-out test”, ASTM D2229-04), Test-H (according to the standard NF ISO 4647 or ASTM D4776-04), peeling (peel-test), etc. The test is then carried out by stressing the specimen until destruction of the interfacial contact zone, of the tearing of the textile, or tearing of the rubber matrix. The adhesion is then evaluated according to criteria such as the appearance of the textile at break, the maximum adhesion force, the average tear-off force, possibly reduced to the thickness of the test piece.

### General Information on the Impregnation Methods

In general, the textile impregnation method is carried out by dipping (soaking) in tanks containing the adhesive preparations. A scheme of such a method is illustrated in Gomes A., Nabih N., Kramer T, Adhesion activation of tire textiles by resorcinol formaldehyde free coatings, Rubber World, March 2016.

The coil(s) of untreated yarns, cords and cables may be positioned on a creel at the line input. An accumulator system may optionally be used. The yarns, cords and cables may be either directly dipped in a tank or impregnated by a lick roller, for the application of the bonding composition. After dipping or impregnation, the excess wet preparation is preferably removed, for example by pressing (padding), suction or by foams.

The drying and/or crosslinking of the bonding composition is then carried out. The coated impregnated textile may thus be subjected to passage through an oven in order to enable the drying and crosslinking of the bonding composition. After removal from an oven, the textile may again undergo an impregnation step, then passage through an oven, these steps being able to be repeated, in particular up to a total of 4 impregnations (2, 3 or 4). On leaving the line, the yarns, cords or cables may be received on winders.

In another method of impregnation, which is particularly suitable for mineral fibers (glass, basalt, carbon, etc.), a derivation system made up of a comb and/or “pig tails” may be used at the creel outlet. It allows maximum opening of the multifilament yarn, to promote thorough impregnation. After the impregnation and drying and/or crosslinking steps, the yarn is then twisted in line. The twisting is preferably carried out on a yarn that has already been treated. Additional treatment processes may be carried out on the cords thus formed.

In the various different methods, the speeds may range from 1 m/min to 150 m/min, with the temperatures of the ovens ranging from 30° C. to 350° C., more specifically from 100 to 300° C., and even more specifically from 140 to 220° . Mechanical tension may also be applied to the textile. Unless otherwise indicated, in the following examples, the textiles were treated with the bonding compositions that are the object of the invention under conditions identical to those applied during a treatment with an RFL.

### Example III-1

### Treated Polyamide 4-6 Reinforcement for Belts

In one example of preparation of the invention, the inventors set out to present a solution which may be used as a reinforcement in assemblies such as transmission belts or conveyor belts.

For this purpose, a cord made of PA 4-6 of construction 470/5×3 dtex (100/125) was constructed by means of successive steps of twisting, and then cabling. The cord obtained was treated by a first impregnation in a solution of methylene diphenyl diisocyanate in toluene, and then subjected to drying and heat setting in an oven. The cord was then impregnated in a tank containing the bonding composition (the adhesive) of the invention, at a concentration by mass of dry matter of 20%, instead of the RFL treatment usually applied. The various different yarns impregnated with the various different adhesives obtained were evaluated for adhesion to a mixture based on EPDM (ethylene-propylene-diene monomer) accelerated with peroxide. The test pieces were produced by compression molding. A yarn impregnated with RFL, produced under the same conditions, made it possible to obtain the control adhesion values. The adhesion values obtained are presented in Table 2, and expressed as % adhesion relative to the adhesion obtained with the control RFL yarn.

### Example III-2

### Treated Glass Reinforcement for Profiles

In one example of preparation of the invention, the inventors set out to present an invention which may be used as a reinforcement in profiles and seals, such as window or door seals. Such reinforcements are made from glass yarn containing a glass fiber sizing with which the bonding composition is to be compatible.

In order to do this, several E-glass yarns of 136 tex strength were subjected to a derivation process and impregnation in the tank containing the bonding composition (the adhesive) of the invention, in place of the RFL. In this example, adhesives with a mass concentration of 20% were evaluated. The impregnated yarns were subjected to drying and heat setting in an oven. On being removed from the oven, the yarns were subjected to a twisting operation so as to confer them with a twist of 135 turns/meter in the Z direction. Three impregnated twists are then cabled together in one direction and at a 135 S level.

The various yarns impregnated with the various adhesives obtained were evaluated for adhesion to an EPDM rubber mixture conventionally implemented in operation by extrusion. The test pieces were produced by compression molding. A yarn impregnated with RFL, produced under the same conditions, made it possible to obtain the control adhesion values. The adhesion values obtained are presented in Table 2, and expressed as % adhesion relative to the adhesion obtained with the control RFL yarn.

### Example III-3

### Treated Polyethylene Terephthalate Reinforcement for Pipes

In another example of preparation of the invention, the inventors set out to present a solution which may be used as a braided, coiled, wrapped or knitted reinforcement in a brake pipe.

Example III-3 (a): For this purpose a 90 Z twist was applied to a polyethylene terephthalate (PET) yarn with a 1100 dtex strength. The yarn obtained was subjected to treatment by an impregnation process in the bonding composition (the adhesive) that is the object of the invention, then by heat setting in an oven. The adhesives used in this example have a dry matter or solids concentration of 20%. The various different yarns impregnated with the adhesive were evaluated for adhesion to an EPDM rubber blend accelerated with peroxide conventionally used in brake pipes. The test pieces were produced by compression molding. A yarn impregnated with RFL, produced under the same conditions, made it possible to obtain the control adhesion values. The values obtained are presented in Table 2, and expressed as % adhesion relative to the adhesion obtained with the control RFL yarn.

Example III-3 (b): In another example, a cord of construction 830/2×3 dtex was constructed by means of successive steps of twisting, and then cabling. The cord obtained was treated by a first impregnation in a solution of methylene diphenyl diisocyanate in toluene, and then subjected to drying and heat setting in an oven. The bonding compositions (adhesives) used in this example have a dry matter or solids concentration of 20%. The various different yarns impregnated with the adhesive were evaluated for adhesion to a rubber mixture based on CR. The test pieces were produced by compression molding. A yarn impregnated with RFL, produced under the same conditions, made it possible to obtain the control adhesion values. The values obtained are presented in Table 2, and expressed as % adhesion relative to the adhesion obtained with the control RFL yarn.

TABLE 2

| Adhesive Compounds | C. II-1 | C. II-2 | C. II-3 | C. II-4 |
|---|---|---|---|---|
| Hardener | | | | |
| Epoxy GE100 | X | X | X | X |
| Lignosulfonate | | | | |
| Sodium | X | X | X | |
| Lignosulphonate | | | | |
| Potassium | | | | X |
| Lignosulphonate | | | | |
| Latex | | | | |
| VP-SBR | X | | | |
| SBR | | X | X | |
| CR | | | | X |
| Additives | | | | |
| Total weight of dry | 20 | 20 | 20 | 20 |
| extract_{theoretical} (%) | | | | |
| Adhesion Test | | | | |
| (in % vs RFL control) | | | | |
| Example III-1 (PA 4-6) | 89 to 98 | | | |
| Example III-2 (E Glass) | | 72 to 77 | | |
| Example III-3 (a) (PET) | | | 131 to 155 | |
| Example III-3 (b) (PET) | | | | 100 to 115 |

The Polyamide 4-6 cord of Example II 1-1 treated with the various different adhesives of Example C.11-1 showed satisfactory levels of adhesion with respect to EPDM as compared to the RFL impregnated control yarn. The adhesion levels obtained, as well as the observation of the fracture patterns show that the adhesives evaluated are compatible with the first impregnation applied to the textile.

The E glass cord of Example III-2 treated with the various different adhesives of Examples C.II-2 showed satisfactory levels of adhesion with respect to EPDM as compared to the RFL impregnated control yarn. Although the latter are lower than those obtained with RFL, they are high enough to ensure the effective performance of the application. The adhesion levels obtained, as well as the observation of the fracture patterns show that the adhesives evaluated are compatible with the sizing of the glass. In addition, the glass yarn thus treated showed no visual damage nor caused excessive fouling on the processing lines. This shows the ability of the adhesives evaluated to impart properties that are identical to RFL, including mechanical protection properties.

The PET yarn of Example III-3 (a), treated with the various different adhesives of each of Example C.II-3 showed higher levels of adhesion with respect to EPDM as compared to the RFL impregnated control yarn. The PET yarn of Example III-3 (b), treated with the various different adhesives of each of Example C.II-4 showed satisfactory levels of adhesion with respect to the CR mixture as compared to the RFL impregnated control yarn.

In conclusion, the results of these various tests clearly demonstrate that the adhesive compositions according to the invention constitute a very interesting alternative to the use of conventional RFL adhesion solutions containing formaldehyde and resorcinol.

1. A bonding composition for textiles, comprising a lignosulfonate salt, an epoxy hardener of this salt, that comprises at least two epoxy units, and an elastomer latex.

2. A composition according to claim 1, in which the lignosulfonate salt is a sodium-, potassium-, magnesium-, ammonium-, or calcium lignosulfonate.

3. A composition according to claim 1, in which the hardener is selected from the group consisting of diglycidyl or poly-glycidyl ethers of aliphatic polyols; diglycidyl or poly-glycidyl ethers of polyfunctional phenols; poly-glycidyl ethers of condensation products of phenols with formaldehyde obtained under acidic conditions; di- or poly-glycidyl esters of aliphatic or aromatic polycarboxylic acids; compounds containing epoxycyclohexyl groups; polyepoxy compounds resulting from the epoxidation of an olefinically unsaturated compound; and mixtures thereof.

4. A composition according to claim 3, in which the hardener is selected from the group consisting of: 1,4 butanediol diglycidyl ether; 2,2-bis(4-hydroxyphenyl) propane diglycidyl ether; Diglycidyl 1,2-cyclohexanedicarboxylate; 3,4-epoxycyclohexylmethyl 3,4 epoxycyclohexanecarboxylate; 1,6 hexanediol diglycidyl ether; Glycerol diglycidyl ether; Glycerol triglycidyl ether; mixture of glycerol diglycidyl ether and glycerol triglycidyl ether; novolac type epoxy resins, and mixtures thereof.

5. A composition according to claim 1, comprising a latex of acrylonitrile/carboxylated butadiene copolymer (XNBR), a latex of acrylonitrile/hydrogenated butadiene (HNBR), a latex of chlorosulfonated polyethylene (CSM), a latex of styrene-butadiene-vinylpyridine copolymer (VPSBR), a latex of styrene/butadiene copolymer (SBR), an acrylonitrile/butadiene copolymer latex (NBR), a polybutadiene (BR) latex, a chlorobutadiene (CR) latex, a natural rubber latex (NR), a polyurethane latex, or a mixture of at least two of them.

6. A composition according to claim 1, in which the mass content of dry matter of the composition is between 2 and 38%.

7.-14. (canceled)

15. The composition according to claim 6, wherein the mass content of dry matter of the composition is between 4 and 30%.

16. The composition according to claim 1, comprising from 40 to 95% by weight of elastomer relative to the composition.

17. The composition according to claim 16, comprising from 55 to 90% by weight of elastomer relative to the composition.

18. The composition according to claim 1, in which the hardener/lignosulfonate salt mass ratio is between 0.01 and 5.

19. The composition according to claim 1, in which the mass ratio [hardener+lignosulfonate salt]/latex mass ratio is between 0.05 and 0.6.

20. The composition according to claim 1, the composition having a neutral or basic pH.

21. The composition according to claim 20, wherein the pH is between 7 and 13.

22. A kit for producing a bonding composition according to claim 1, the kit comprising a first composition comprising a lignosulfonate salt and an elastomer latex and a second composition comprising an epoxy hardener of the lignosulfonate salt, that comprises at least two epoxy units.

23. A method to impart adhesion properties to a reinforcement textile, with respect to a rubber, comprising coating and/or impregnating said textile with a composition according to claim 1.

24. A reinforcement textile at least partially coated and/or impregnated with a bonding composition according to claim 1.

25. The reinforcement textile according to claim 24, which textile is a yarn, a cord or a textile structure.

26. A part made of rubber or comprising a rubber, in which the rubber comprises at least one reinforcement textile according to claim 24, on the surface and/or integrated inside the rubber.
